(19) United States
(12) Patent Application Publication
(10) Pub. No.: US 2010/0171339 A1
(43) Pub. Date: Jul. 8, 2010

(54) Support Element for a Cockpit Beam

(75) Inventors: Markus Zörnack, Dortmund (DE); Mark Hirt, Bochum (DE); Peter Seyfried, Dortmund (DE); Christian Dornscheidt, Dusseldorf (DE); Matthias Hein, Gelsenkirchen (DE); Martin Hinz, Issum (DE); Paul Angenheister, Kempen (DE); Thomas Beer, Grefrath (DE); Alfred Mai, Huckeswagen (DE); Klaus Kierspel, Rosrath (DE); Norberto Silva, Essen (DE); Jochen Zimmermann, Wuppertal (DE); Viktor Arbanas, Baden (CH); Michael Maag, Kreuzlingen (CH); Carsten Manneck, Feldkirch (AT); Max Oertle, Mauren (LI)

Correspondence Address: PROSKAUER ROSE LLP, ONE INTERNATIONAL PLACE, BOSTON, MA, 02110, US

(73) Assignee: JOHNSON CONTROLS GMBH, Burscheid (DE)

(21) Appl. No.: 12/306,108

(22) PCT Filed: Jun. 28, 2007
(86) PCT No.: PCT/EP2007/056479

§ 371 Date: Jan. 14, 2010

(30) Foreign Application Priority Data
Jun. 28, 2006 (DE) 10 2006 030 131.5
Nov. 3, 2006 (DE) 10 2006 052 281.8

(51) Int. Cl. B62D 25/14; B62D 65/02

(52) U.S. Cl. 296/193.02

(57) ABSTRACT

A support element for a cockpit structure of a motor vehicle with a body, as well as a cockpit structure of a motor vehicle, which is provided in the area between the A-columns of the body of a motor vehicle, includes at least one cockpit carrier and a support element. This cockpit structure which on the one hand is optimized in respect of the material consumption, and at the same time makes shorter manufacturing times possible, as well as, on the other hand, fulfills the safety requirements in the event of an offset and/or lateral impact, has a modular design and, by the use of different cockpit structure parts, in particular different cockpit carriers and/or support elements, can be adapted to the individual body concerned.

### CROSS-REFERENCE TO RELATED APPLICATIONS

This application is a National Phase Application of International Application No. PCT/EP2007/056479, filed on Jun. 28, 2007, which claims the benefit of and priority to German patent application no. DE 10 2006 030 131.5, filed Jun. 28, 2006, and German patent application no. DE 10 2006 052 281.8, filed Nov. 3, 2006. The disclosures of the above applications are incorporated herein by reference in their entirety.

### FIELD OF THE INVENTION

The invention relates to a cockpit structure of a motor vehicle, comprising at least one cockpit carrier, which is provided in the area between the A-columns of the body of a motor vehicle and is of modular design, and which, by the use of different cockpit structure parts, can be adapted to the individual body.

### BACKGROUND

Measures for bracing the safety cell in the driver and passenger areas of a motor vehicle by means of the cockpit structure are known from the prior art. Thus, for example, the German Published Application DE 34 19 002 A1 discloses a material-optimized bracing of the safety cell, which in particular increases the rigidity in the event of an offset and side impact. The bracing is achieved by the fact that diagonal braces are provided, which, starting from the floor of the body, run diagonally outwards and are connected to a transverse support member running beneath the windscreen, and run symmetrically to the middle longitudinal axis of the vehicle. A disadvantage with the known motor vehicle cockpit structure is that it is an integral component of the body of the vehicle. Each vehicle therefore acquires a very complex unique structure with regard to the bracing of the safety cell of the motor vehicle, such that the costs for the manufacture of the body are increased. The known diagonal braces also partially impede the final assembly of the motor vehicle, for example during the installation of further components, so increasing the final assembly times of the vehicle. The diagonal braces also reduce the space in the passenger cell in the area of the driver and passenger. Finally, the need also arises for the material consumption to be reduced for measures for bracing the safety cell of a motor vehicle. This also relates in particular to the entire cockpit structure of the vehicle, which hitherto, as disclosed in the prior art referred to heretofore, is specifically designed for the individual vehicle types and is an integral part of the body.

### SUMMARY OF THE INVENTION

In general, in one aspect, the invention provides a cockpit structure which on the one hand is optimized with regard to material consumption and allows for shorter manufacturing times, and on the other hand, fulfills the safety requirements in the event of an offset and/or side impact.

According to a first embodiment of the present invention, the cockpit structure is of modular design and, with the use of different cockpit structure parts, in particular different cockpit carriers and/or support elements, is capable of being adapted to the individual body in each case.

Previous cockpit structures have as a rule an individually designed cockpit carrier running continuously from the left to the right A-column. A modular design of the cockpit structure of a motor vehicle has not hitherto been known. Thanks to the modular arrangement, with the use of different cockpit structure parts, such as support elements and cockpit carriers, the cockpit structure can be easily adapted to different motor vehicle types. Furthermore, it is possible, for example, to make use of the cockpit carrier or the support element for different bodies, which leads to reduced manufacturing costs.

According to an embodiment, the cockpit structure has as cockpit structure parts at least one cockpit carrier and precisely one support element, wherein the support element is formed of metal and has connecting members for the connection of the support element to the cockpit carrier, a transverse support member beneath the windscreen, in particular the cowl and a floor area or tunnel area of the body of the motor vehicle, such that the support element can be connected to the cockpit carrier, the transverse support member and the floor or tunnel of the body of the motor vehicle by a force closure, a form closure and/or material closure.

It has surprisingly been shown that a cockpit structure with a single support element made of metal, arranged, for example, on the driver's side, which runs from the floor or tunnel of the body to a transverse support member beneath the windscreen or the cowl and is connected to this and the cockpit carrier as well as to the floor area of the body, can fulfill usual crash requirements. The cockpit structure according to the invention is not only associated with a reduction of vibrations at the steering column, but leads likewise to an improvement of the crash behavior of the steering column. At the same time, the material consumption for the bracing of the safety cell in the front area is perceptibly reduced, since no additional support elements are necessary, such as diagonal bracing elements. The support element consists of a metal, in particular of steel or a steel alloy. This guarantees that the support element has the necessary strength to be able to fulfill the usual crash requirements. Thanks to the connecting means provided for the connecting of the support element to the cockpit carrier, the transverse support member beneath the windscreen and the floor area of the body, it is possible, in addition, for the support element not to be connected to the body and/or the cockpit carrier, by means of a force closure, a form closure and/or a material closure, until during the final assembly of the motor vehicle. As connecting members, use can be made, for example, of flange areas at the ends of the support element for the securing of the support element to the body, i.e. for example the transverse support member or the cowl or the floor area, respectively, as well as a laterally located mounting plate for the securing of the cockpit carrier.

Preferably, the cockpit structure parts have adapted connecting members which allow for a combination of different cockpit structure parts, in order to adapt the cockpit structure to the individual vehicle body. For example, adapted connecting members can be realized by means of uniform or even identical connecting at the individual cockpit structure parts, in particular at the support element or the cockpit carrier.

If the cockpit structure is constructed at least partially from metal and/or plastic, the cockpit structure can at the same time be optimized in respect of its weight, costs, and rigidity.

According to a further embodiment, both the costs for the manufacture of a cockpit structure according to the invention as well as the weight can be reduced, with very good properties with regard to rigidity and eigen frequency, due to the fact that on only one side, in particular on the driver's side, a cockpit carrier made of metal is provided, in particular made of steel or a steel alloy. For the driver's side of a motor vehicle, the steering column connection usually imposes higher demands for rigidity, which are fulfilled by the cockpit carrier made of metal. Other constituent parts of the cockpit structure, such as the passenger's side, do not require a continuous carrier structure made of metal, and can, for example, be made of plastic in order to save costs.

A cockpit carrier which is arranged substantially horizontally allows for a simplified structure of the modular cockpit structure, for example with regard to the steering column connection.

If the cockpit carrier has at least one closed hollow profile with variable cross-section, then an improved utilization of material can achieve a reduction in weight.

According to a further embodiment, the cockpit structure can be integrated into the body in the final assembly of the motor vehicle, such that the cockpit structure does not impede the installation of other components into the body of the motor vehicle and the manufacturing times of a motor vehicle can thereby be optimized.

According to a further embodiment of the cockpit structure according to the invention, the support element connected to the cockpit carrier has the shape of a tripod. The tripod formed by the support element and the cockpit carrier has the effect of bracing the safety cell by the support element and cockpit carrier alone in three spatial directions, such that exceptionally few components are required for the bracing of the safety cell of a motor vehicle.

If the support element of the cockpit structure has at least one at least partially closed, open, and/or curved profile, the support element can be optimally adapted to the loads when in use. The support element is optimized in respect of weight and eigen frequencies of the cockpit carrier structure and, for example, the steering column connection. The structure optimization serves to reduce the weight with the same technical performance. The profiles used are optimized with regard to their eigen frequency, such that resonances are adequately damped. Closed profiles have very high degrees of rigidity, and can also be produced by simple methods, for example by the curling technique or roll forming technique. Open profiles, usually provided with lesser strength properties, are even more economical.

For further weight and loading optimization, the support element preferably has a variable cross-section, in order to be adapted to crash loadings while having lower weight.

According to a preferred embodiment, the support element is designed as one piece continuously from the transverse support member beneath the windscreen, in particular the cowl, as far as to the floor area of the body, such that as few parts as possible are required for the manufacture of the cockpit structure.

For the simple connection of the support element to the cockpit carrier, the support element can have a first connection area for the connection of the support element to the cockpit carrier by flanges, wherein this connection area has at least parallel edge areas for the accommodation of the flanges of the cockpit carrier. In addition, by means of the connection of the cockpit carrier and the support element by flanges, a particularly stable and easily created connection can be guaranteed.

If the support element has a connection area (e.g., a second connection area) for the connection of the support element to the cowl and/or another transverse support member, which in the form of an arm begins substantially horizontally from the first connection area for the connection to the cockpit carrier and ends substantially perpendicularly in the area of the connection to the transverse support member or the cowl of the body, then the crash behavior of the cockpit structure according to the invention can be improved, since the support element can likewise effectively sustain vertically imposed forces of the transverse support member and/or cowl.

A further improvement of the crash behavior is achieved according to a further embodiment, in that the first and second connection areas of the support element for the connection of the support element to the cockpit carrier and the cowl and/or transverse support member are braced by an insert, which is adapted in these areas to the contour of the support element designed as an open hollow profile.

Preferably, the insert in an installed state in an accommodation and connection area of the support element forms a partially closed hollow profile together with this support element, such that a high degree of rigidity is achieved.

Tolerances which arise with the installation of the cockpit structure into the body of a motor vehicle can be taken into account according to a further embodiment of the cockpit structure according to the invention in that, to connect the support element to the floor area of the body, a connection element is provided which can be inserted into the support element and can be displaced relative to the support element and/or relative to the floor area. As a result of the displacement, it is possible in particular for the cockpit structure to be installed almost free of tension into the passenger cell.

Preferably, the support element and/or the connection element which can be inserted into the support element can have longitudinal holes for this purpose. It is also conceivable, however, for corresponding longitudinal holes or similar measures for compensating tolerance to be provided in the floor area of the body.

The effort and expenditure for the manufacture of the cockpit structure can be reduced by the support element running substantially vertically, seen in the longitudinal direction of the motor vehicle, since the manufacturing effort for a corresponding support element is reduced.

An alternative connection of the support element to the transverse support member or cowl and the cockpit carrier is provided in that the support element in a third connection area with the transverse support member runs substantially horizontally and/or in a fourth connection area with the floor area of the body runs substantially vertically. This alternative design of the support element also provides the necessary improvement in the crash behavior, with a reduced number of cockpit components. In addition to this, due to the substantially horizontally running connection area with the transverse support member running beneath the windscreen, in particular the cowl, this can be particularly easily realized. The substantially vertically running connection area of the support element with the floor or tunnel of the body allows for a simple and space-saving connection to the floor or tunnel area of the body of the motor vehicle.

The connection of the cockpit carrier to the support element can, as an alternative, between the horizontally and vertically running areas of the support element, wherein preferably the transverse support member runs horizontally.

Curved profiles allow for a simple connection to the transverse support member beneath the windscreen or the cowl and to the floor or tunnel of the body. Use can also be made, however, of any desired combination of closed, open, and curved profiles, for example, in order to fulfill the requirements for the support element when in use.

According to another advantageous embodiment of the invention, the support element has at least a closed hollow profile with variable cross-section. As a result, the support element can be made of what are referred to as “modular tubes”, which can be designed in an optimum manner to the loads when in use, such that a minimum weight with maximum rigidity can be guaranteed.

Finally, the support element according to the invention is designed advantageously in such a way that the support element is designed as one piece continuously from the transverse support member beneath the windscreen, in particular from the cowl, as far as to the floor or tunnel of the body. With the one-piece support element, it is possible, with a minimal number of components, nevertheless to guarantee all safety requirements with regard to the rigidity and a low number of resonances of the safety cell of a motor vehicle. This results in especially low manufacturing costs for the support element according to the invention.

### BRIEF DESCRIPTION OF THE DRAWINGS

There are a large number of possible embodiments, including various types of the support element according to the invention or the cockpit structure according to the invention. To this effect, reference is made to the description of two embodiments in conjunction with the drawings. The drawings show:

FIG. 1: A three-dimensional view of the driver's side part of an embodiment of a cockpit structure according to the invention.

FIG. 2: A three-dimensional view of the driver's side part of a second embodiment of a cockpit structure according to the invention.

FIG. 3: A three-dimensional view of the embodiment from FIG. 2 from the passenger's side.

### DESCRIPTION

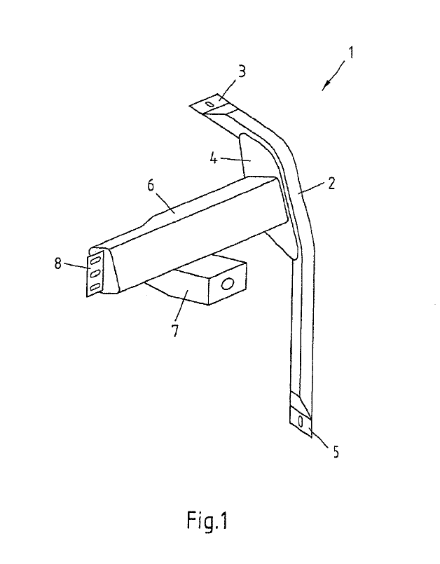

FIG. 1 shows a first embodiment of a cockpit structure 1 according to the invention, which is made up of a support element 2 with connecting members 3, 4 and 5, and a cockpit carrier 6. In addition, in FIG. 1 a steering column 7 is further shown, mounted at the cockpit carrier 6. The connection of the cockpit carrier 6 to the A-column is effected by means of connecting member 8.

In the embodiment in FIG. 1, the support element 2 is represented as a closed hollow profile with an approximately square cross-section. The connection area for connecting the support element 2 to a transverse support member or the cowl of the vehicle body, respectively, has connecting member 3, which connect the support element 2 to a transverse support member, in particular the cowl of the vehicle, not shown, and which runs substantially horizontally. At the opposite end of the support element 2, the connection area of the support element 2, with the connection member 5 for the connection to the floor of the body, runs substantially vertically. The support element 2 is curved in order for this shape to be formed. In addition, a retaining plate 4 can be mounted at the curved support element in order to secure the cockpit carrier 6, in order to obtain a cockpit structure with high rigidity and good properties with regard to eigen frequencies. By means of the retaining plate 4 arranged laterally at the support element 2, the cockpit carrier 6 can be easily connected to the support element 2. The retaining plate 4 is preferably arranged in the area of the curve of the support element 2, laterally to the support element 2, and can therefore additionally stabilize both the vertical and the horizontal part of the support element 2. If the support element 2 is designed as one piece, connection members can be provided for connecting the support element 2 to the cockpit carrier 6 in that, for example, drill holes are provided for bolts or rivets for the retaining plate 4, which is then fitted to the cockpit carrier 6, or even just one surface is provided which is suitable for the welding of the cockpit carrier 6.

The support element 2 represented in FIG. 1 is preferably manufactured from steel or a steel alloy, wherein known economical manufacturing processes for closed hollow profiles can be used, such as curl techniques or roll forming profiles.

For realization of the modular construction of the cockpit structure, the connection members 3, 4 and 5 are designed uniformly for the different cockpit structure parts, such as the cockpit carrier 6 or the support element 2, such that any desired combinations of different cockpit structure parts can be made possible.

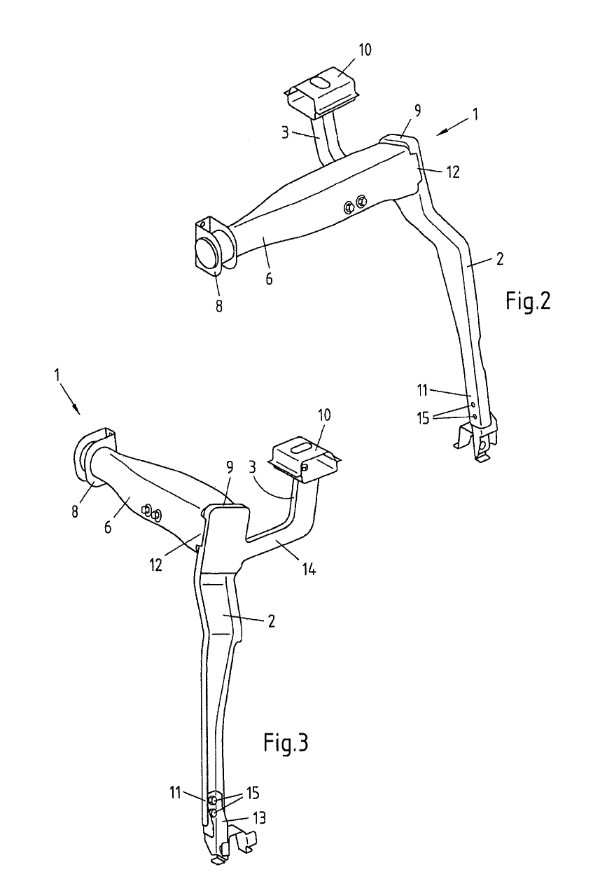

In FIGS. 2 and 3 a second embodiment of a cockpit structure 1 is shown in a perspective view. FIG. 2 shows the second embodiment in a perspective view from the driver's side and FIG. 3 from the passenger's side.

In contrast to the embodiment shown in FIG. 1, the connection area 3 of the support element 2 runs from a connection area 9 to the connection to the cockpit carrier 6 in the form of an arm, initially horizontally, in order then to bend vertically in the direction of a cowl or transverse support member 10. The support element 2 is constructed from an open profile, which runs continuously from the connection area at the cowl or transverse support member 10, respectively, to the connection area 11 at the floor area or tunnel area of the vehicle body.

With the second embodiment, the connection members for connecting to the cockpit carrier 6 are integrated as the connection area 9 into the support element 2. The cockpit carrier 6 is secured to the support element 2 by flanges 12, which are in contact at the connection area 9 of the support element 2, and therefore forms a structure in the form of a tripod, which produces substantial bracing of the safety cell of the motor vehicle. At the other end of the cockpit carrier 6, which consists, for example, of a “modular tube” with changeable cross-section, connection member 8 for connecting the cockpit structure to the A-column of a motor vehicle are provided.

Both in FIG. 2 and in FIG. 3, further bolts 15 are represented as connection members for the connection of the support element 2 to the cowl or transverse support member, for example, or to the floor or tunnel area of the body, respectively. The connection element 13 serves on the one hand to enable a flexible connection, compensating for tolerances, to the floor or tunnel area. On the other hand, by the use of the connection element 13 it is possible to dispense with complex shaping of the end area of the support element 2.

In FIG. 3 an insert 14 can additionally be identified, which is inserted with the rear side into the support element 2 at least in the connection area 9 to the cockpit carrier 6 and in the connection area 3 of the support element 2, running in the form of an arm in the direction of the cowl or transverse support member 10. Due to the insert 14, the entire area of the support element 2 in which the insert is arranged is provided with bracing. The support element 2 is of complex form in order to optimize it to the installation situation of the cockpit carrier 6 in the motor vehicle, wherein the shape of the open profile of the support element 2 is preferably obtained by deep-drawing. Other manufacturing processes are however possible.

1. Cockpit structure of a motor vehicle, which is provided in the area between the A-columns of the body of a motor vehicle, comprising at least one cockpit carrier and one support element, wherein the cockpit structure is of modular design and further comprises different cockpit structure parts, that can be adapted to the individual body, wherein the support element is formed of metal and has connection members for connection of the support element to the cockpit carrier, a transverse support member beneath a windscreen, such that the support element can be connected to the cockpit carrier, the transverse support member and the floor or tunnel of the body of the motor vehicle, by a force closure, a form closure and/or a material closure.

2. (canceled)

3. Cockpit structure according to claim 1, wherein the cockpit structure parts have connection members, which allow for a combination of different cockpit structure parts with one another.

4. Cockpit structure according to claim 1, wherein the cockpit structure is constructed at least in part from metal and/or plastic.

5. Cockpit structure according to claim 1, wherein on one side a cockpit carrier made of metal, in particular steel or a steel alloy is provided.

6. Cockpit structure according to claim 1, wherein the cockpit carrier runs substantially horizontally.

7. Cockpit structure according to claim 1, wherein the cockpit carrier has at least one closed hollow profile with variable cross-section.

8. Cockpit structure according to claim 1, wherein the cockpit structure can be installed into the body in a final assembly of the motor vehicle.

9. Cockpit structure according to claim 1, wherein the support element connected to the cockpit carrier has the shape of a tripod.

10. Cockpit structure according to claim 1, wherein the support element has a profile selected from the group consisting of at least partially closed, open, and curved, and combinations thereof.

11. Cockpit structure according to claim 1, wherein the support element has a variable cross-section.

12. Cockpit structure according to claim 1, wherein the support element is designed as one piece continuously from the transverse support member beneath the windscreen as far as to the floor of the body.

13. Cockpit structure according to claim 1, wherein the support element has a first connection area for the connection of the support element to the cockpit carrier by flanges, wherein this connection area has at least parallel edge areas for the accommodation of the flanges of the cockpit carrier.

14. Cockpit structure according to claim 1, wherein the support element has a second connection area for the connection of the support element to a cowl and/or another transverse support member, which in the form of an arm begins substantially horizontally from the first connection area for the connection to the cockpit carrier and ends perpendicularly in an area of the connection to the transverse support member or the cowl of the body.

15. Cockpit structure according to claim 1, wherein first and second connection areas of the support element for the connection of the support element to the cockpit carrier and a cowl and/or the transverse support member, respectively, are braced by an insert element, which is adapted in these areas to the contour of the support element designed as an open hollow profile.

16. Cockpit structure according to claim 15, wherein the insert element in an installed state in an accommodation and connection area of the support element forms a partially closed hollow profile together with this support element.

17. Cockpit structure according to claim 1, wherein, for connection of the support element to the floor area of the body, a connection element is provided which can be inserted into the support element and can be displaced relative to the support element and/or relative to the floor area.

18. Cockpit structure according to claim 17, wherein the support element and/or the connection element capable of being inserted into the support element have longitudinal holes.

19. Cockpit structure according to claim 1, wherein the support element runs substantially vertically in the longitudinal direction of the motor vehicle.

20. Cockpit structure according to claim 1, wherein the support element runs substantially horizontally in a third connection area with the transverse support member and/or runs substantially vertically in a fourth connection area with the floor area of the body.
